(19) United States
(12) Patent Application Publication
(10) Pub. No.: US 2025/0229663 A1
(43) Pub. Date: Jul. 17, 2025

(54) ELECTRICAL CHARGING AND SWAPPING STATION OF A BATTERY TENDER

(71) Applicant: VOLTIFY INC., Philadelphia, PA (US)

(72) Inventor: Alon KESSEL, Ramat Gan (IL)

(21) Appl. No.: 19/022,215

(22) Filed: Jan. 15, 2025

(30) Foreign Application Priority Data
Jan. 17, 2024 (IL) 310228

(51) Int. Cl. B60L 53/64; B60L 53/35; B60L 53/80; B61K 11/00; H02J 3/00; H02J 7/00; H02J 7/02

(52) U.S. Cl. CPC B60L 53/64; B60L 53/35; B60L 53/80; B61K 11/00; H02J 3/003; H02J 7/0042; H02J 7/02; B60L 2200/26; B60L 2210/30

(57) ABSTRACT

The present invention discloses a charging and swapping station of a battery tender, a battery charging system and a method for assembling charging station within an existing rail network.

### CROSS REFERENCE TO RELATED APPLICATIONS

This application claims the benefit of priority of Israeli Patent Application No. 310228, filed on Jan. 17, 2024, the contents of which are all incorporated herein by reference in their entirety.

### FIELD OF THE INVENTION

The present invention pertains to a method, system, and battery charging station.

### BACKGROUND OF THE INVENTION

The majority of worldwide freight locomotives and some passenger locomotives use diesel as their sole energy source. Diesel engines produce gases harmful to human health, particularly NOx and PM, as well as environmentally harmful gases like CO2. Due to these reasons, various regulatory measures worldwide impose restrictions on the operation of low-tier (high-emission) locomotives, limiting their operational longevity.

One promising technology for zero-emission locomotives involves using batteries as the power source. However, a major disadvantage of battery locomotives is the operational time lost during the lengthy charging required for high-capacity batteries.

Therefore, there is an imminent need for an optimized energy-efficient system, for charging high-capacity batteries while reducing the time lost during the lengthy charging required for high-capacity batteries.

### SUMMARY OF THE INVENTION

It is hence an object of the invention to disclose a charging and swapping station of a battery tender.

According to an aspect of the invention, there is provided a battery charging station (CS) (100) along a railroad track, characterized by at least one weather-proof battery charging post (110) located below the railroad track.

In some embodiments, the at least one weather-proof battery charging post (110) is contained within a weatherproof compartment (115)

In some embodiments, the weatherproof compartment (115) is for protecting the at least one battery charging post (110) from environmental and weather conditions.

In some embodiments, the weatherproof compartment (115) comprises a metal, metal oxide, ceramics, polymers, or compositions, including any combination thereof.

In some embodiments, the weatherproof compartment (115) comprises cement.

In some embodiments, the weatherproof compartment (115) comprises a slidable cover (120).

In some embodiments, the at least one battery charging post (110) comprises (i) at least one pair of current collectors (112); (ii) a proximity sensor (116) for sensing presence of a battery tender above the at least one battery charging post; and (iii) a spring-loaded mechanism or a pneumatic system (118) for elevating and lowering the current collectors upon detection of the presence of a battery tender (300).

In some embodiments, the at least one battery charging post further comprises an at least one charging rail cleaner (114) configured to clean rail and busbars under a battery tender.

In some embodiments, the CS comprises a dual power source (410, 420) configured to supply power to the at least one battery charging post (110).

In some embodiments, the dual power source comprises on-grid power source (410) and off-grid power source (420).

In some embodiments, the power supplied (148, 152, 170) to the at least one battery charging post (110) is characterized by a current lower than 1500 Volt DC.

In some embodiments, the CS comprises an energy management system (EMS) (160).

In some embodiments, the EMS (160) is configured to continuously control current supplied by the dual power source.

In some embodiments, the EMS (160) comprises (i) a DC busbar (138) connected to the power supply (170) and the at least one battery charging post (110); (ii) a point-to-point communication line (136) with each the at least battery charging post (110); (iii) a wireless communication (133) for enabling communication between the EMS (133) and the battery tender (300) and/or higher-level systems (200); and (iv) computer (130) configured to enable data processing and optimization of the charging.

In some embodiments, the EMS (160) is connectable to at least 2 DC (170) that are connected to at least one battery charging post.

In some embodiments, the at least 2 DC (170) are controlled by the EMS (160).

In some embodiments, the EMS is configured to at least (i) process and analyze data obtained from the power supply, battery EMS, bus bar, including any combination thereof; (ii) apply analytical modules to assess energy efficiency, forecast consumption and identify opportunities for optimization, including any combination thereof; (iii) utilize optimization algorithms to determine an energy-efficient operation strategy including cost, demand response, and environmental response; (iv) report, alert and notify on performance indicators, abnormal conditions, potential energy waste, and opportunities for improvement; and (v) monitor the impact of implemented strategies and adjusting parameters.

In some embodiments, the CS comprises a power supply converter (142, and 146) for converting alternating current (144) to direct current (DC) (148).

In some embodiments, the power supply converter comprises a transformer (142) configured to lower the on-grid power source (410) to 1500 Volt ac; and a rectifier or a bi-directional inverter (146) for converting the 1500 Volt AC to DC 148.

In some embodiments, the CS comprises a battery swapping installation for replacing at least one onboard locomotive battery with an externally stored charged battery.

In some embodiments, a battery tender comprises (i) at least two rail busbars (331 and 332); (ii) battery management system (BMS); and (iii) battery tender EMS.

In some embodiments, power is supplied by closing an electrical circuit between the current collectors (112) and the at least two rail busbars (331 and 332).

In some embodiments, the CS is integrated into an existing rail network.

According to another aspect of the invention, there is provided a method for assembling a charging station (100) within an existing rail network comprising an at least one weather-proof battery charging post (110) located below a railroad track.

In some embodiments, the at least one weather-proof battery charging post (110) is contained within a weatherproof compartment (115).

In some embodiments, the weatherproof compartment (115) is for protecting the at least one battery charging post (110) from environmental and weather conditions.

In some embodiments, the weatherproof compartment (115) comprises a metal, metal oxide, ceramics, polymers, or compositions, including any combination thereof.

In some embodiments, the weatherproof compartment (115) comprises cement.

In some embodiments, the weatherproof compartment (115) comprises a slidable cover (120).

In some embodiments, the at least one battery charging post (110) comprises (i) at least one pair of current collectors (112); (ii) a proximity sensor (116) for sensing presence of a battery tender above the at least one battery charging post; and (iii) a spring-loaded mechanism or a pneumatic system (118) for elevating and lowering the current collectors upon detection of the presence of a battery tender (300).

In some embodiments, the at least one battery charging post further comprises an at least one charging rail cleaner (114) configured to clean rail and busbars under a battery tender.

In some embodiments, the method comprises a dual power supply (410, 420) configured to supply power to the at least one battery charging post (110).

In some embodiments, the dual power source comprises on-grid power source (410) and off-grid (420) power source.

In some embodiments, the power supplied (148, 152, 170) to the at least one battery charging post (110) is characterized by a current lower than 1500 Volt DC.

In some embodiments, the method comprises an energy management system (EMS) (160).

In some embodiments, the EMS (160) is configured to continuously control current supplied by the dual power source.

In some embodiments, the EMS (160) comprises (i) a DC busbar (138) connected to the power supply (170) and the at least one battery charging post (110); (ii) a point-to-point communication line (136) with each the at least battery charging post (110); (iii) a wireless communication (133) for enabling communication between the EMS (133) and the battery tender (300) and/or higher-level systems (200); and (iv) computer (130) configured to enable data processing and optimization of the charging.

In some embodiments, the EMS (160) is connectable to at least 2 DC (170) that are connected to at least one battery charging post.

In some embodiments, the at least 2 DC (170) are controlled by the EMS (160).

In some embodiments, the EMS is configured to at least (i) process and analyze data obtained from the power supply, battery EMS, bus bar, including any combination thereof; (ii) apply analytical modules to assess energy efficiency, forecast consumption and identify opportunities for optimization, including any combination thereof; (iii) utilize optimization algorithms to determine an energy-efficient operation strategy including cost, demand response, and environmental response; (iv) report, alert and notify on performance indicators, abnormal conditions, potential energy waste, and opportunities for improvement; and (v) monitor the impact of implemented strategies and adjusting parameters.

In some embodiments, the method comprises a power supply converter (142, and 146) for converting alternating current (144) to direct current (DC) (148).

In some embodiments, the power supply converter comprises a transformer (142) configured to lower the on-grid power source (410) to 1500 Volt ac; and a rectifier (146) or a bi-directional inverter for converting the 1500 Volt AC to DC 148.

In some embodiments, the method comprises a battery swapping installation for replacing at least one onboard locomotive battery with an externally stored charged battery.

In some embodiments, a battery tender comprises (i) at least two charging rail busbars (331 and 332); (ii) battery management system (BMS); and (iii) battery tender EMS.

In some embodiments, power is supplied by closing an electrical circuit between the current collectors (112) and the at least two charging rail busbars (331 and 332).

According to another aspect of the invention, there is provided a method for charging a battery tender (300) comprising (i) the battery tender (300); and (ii) an at least one weather-proof battery charging post (110) located below a rail road track.

In some embodiments, the at least one weather-proof battery charging post (110) is contained within a weatherproof compartment (115).

In some embodiments, the weatherproof compartment (115) is for protecting the at least one battery charging post (110) from environmental and weather conditions.

In some embodiments, the weatherproof compartment (115) comprises a metal, metal oxide, ceramics, polymers, or compositions, including any combination thereof.

In some embodiments, the weatherproof compartment (115) comprises cement.

In some embodiments, the weatherproof compartment (115) comprises a slidable cover (120).

In some embodiments, the at least one battery charging post (110) comprises (i) at least one pair of current collectors (112); (ii) a proximity sensor (116) for sensing presence of a battery tender above the at least one battery charging post; and (iii) a spring-loaded mechanism or a pneumatic system (118) for elevating and lowering the current collectors upon detection of the presence of a battery tender (300).

In some embodiments, the at least one battery charging post further comprises an at least one charging rail cleaner (114) configured to clean rail and busbars under a battery tender.

In some embodiments, the method comprises a dual power supply (410, 420) configured to supply power to the at least one battery charging post (110).

In some embodiments, the dual power source comprises on-grid power source (410) and off-grid power source (420).

In some embodiments, the power supplied (148, 152, 170) to the at least one battery charging post (110) is characterized by a current lower than 1500 Volt DC.

In some embodiments, the method comprises an energy management system (EMS) (160).

In some embodiments, the EMS (160) is configured to continuously control current supplied by the dual power source.

In some embodiments, the EMS (160) comprises (i) a DC busbar (138) connected to the power supply (170) and the at least one battery charging post (110); (ii) a point-to-point communication line (136) with each the at least battery charging post (110); (iii) a wireless communication (133) for enabling communication between the EMS (133) and the battery tender (300) and/or higher-level systems (200); and (iv) computer (130) configured to enable data processing and optimization of the charging.

In some embodiments, the EMS (160) is connectable to at least 2 DC (170) that are connected to at least one battery charging post.

In some embodiments, the at least 2 DC (170) are controlled by the EMS (160).

In some embodiments, the EMS is configured to at least (i) process and analyze data obtained from the power supply, battery EMS, bus bar, including any combination thereof; (ii) apply analytical modules to assess energy efficiency, forecast consumption and identify opportunities for optimization, including any combination thereof; (iii) utilize optimization algorithms to determine an energy-efficient operation strategy including cost, demand response, and environmental response; (iv) report, alert and notify on performance indicators, abnormal conditions, potential energy waste, and opportunities for improvement; and (v) monitor the impact of implemented strategies and adjusting parameters.

In some embodiments, the method comprises a power supply converter (142, and 146) for converting alternating current (144) to direct current (DC) (148).

In some embodiments, the power supply converter comprises a transformer (142) configured to lower the on-grid power source (410) to 1500 Volt ac; and a rectifier (146) or a bi-directional inverter for converting the 1500 Volt AC to DC 148.

In some embodiments, the method comprises a battery swapping installation for replacing at least one onboard locomotive battery with an externally stored charged battery.

In some embodiments, a battery tender comprises (i) at least two charging rail busbars (331 and 332); (ii) battery management system (BMS); and (iii) battery tender EMS.

In some embodiments, power is supplied by closing an electrical circuit between the current collectors (112) and the at least two rail busbars (331 and 332).

A battery charging system comprising an at least one weather-proof charging unit located below a railroad track.

In some embodiments, the weather-proof charging unit comprises at least one weather-proof battery charging post (110) comprising (i) at least one pair of current collectors (112); (ii) a proximity sensor (116) for sensing presence of a battery tender above the at least one battery charging post; and (iii) a spring-loaded mechanism or a pneumatic system (118) for elevating and lowering the current collectors upon detection of the presence of a battery tender (300).

In some embodiments, the at least one battery charging post further comprises at least one charging rail cleaner (114) configured to clean rail and busbars under a battery tender.

In some embodiments, the at least one weather-proof battery charging post (110) is contained within a weatherproof compartment (115).

In some embodiments, the weatherproof compartment (115) is for protecting the at least one battery charging post (110) from environmental and weather conditions.

In some embodiments, the weatherproof compartment (115) comprises a metal, metal oxide, ceramics, polymers, or compositions, including any combination thereof.

In some embodiments, the weatherproof compartment (115) comprises cement.

In some embodiments, the weatherproof compartment (115) comprises a slidable cover (120).

In some embodiments, the system comprises power unit comprising a dual power supply (410, 420) configured to supply power to the at least one battery charging post (110).

In some embodiments, the dual power source comprises on-grid power source (410) and off-grid (420) power source.

In some embodiments, the power supplied (148, 152, 170) to the at least one battery charging post (110) is characterized by a current lower than 1500 Volt DC.

In some embodiments, the system comprises an energy management system (EMS) (160).

In some embodiments, the EMS (160) is configured to continuously control current supplied by the dual power source.

In some embodiments, the EMS (160) comprises (i) a DC busbar (138) connected to the power supply (170) and the at least one battery charging post (110); (ii) a point-to-point communication line (136) with each the at least battery charging post (110); (iii) a wireless communication (133) for enabling communication between the EMS (133) and the battery tender (300) and/or higher-level systems (200); and (v) computer (130) configured to enable data processing and optimization of the charging.

In some embodiments, the EMS (160) is connectable to at least 2 DC (170) that are connected to at least one battery charging post.

In some embodiments, the at least 2 DC (170) are controlled by the EMS (160).

In some embodiments, the EMS is configured to at least (i) process and analyze data obtained from the power supply, battery EMS, bus bar, including any combination thereof; (ii) apply analytical modules to assess energy efficiency, forecast consumption and identify opportunities for optimization, including any combination thereof; (iii) utilize optimization algorithms to determine an energy-efficient operation strategy including cost, demand response, and environmental response; (iv) report, alert and notify on performance indicators, abnormal conditions, potential energy waste, and opportunities for improvement; and (v) monitor the impact of implemented strategies and adjusting parameters.

In some embodiments, the system comprises a power converting unit (142, and 146) for converting alternating current (144) to direct current (DC) (148).

In some embodiments, the power converting unit comprises a transformer (142) configured to lower the on-grid power source (410) to 1500 Volt ac; and a rectifier (146) or a bi-directional inverter for converting the 1500 Volt AC to DC 148.

In some embodiments, the system comprises a battery swapping installation for replacing at least one onboard locomotive battery with an externally stored charged battery.

In some embodiments, a battery tender comprises (i) at least two charging rail busbars; (ii) battery management system (BMS); and (iii) battery tender EMS.

In some embodiments, power is supplied by closing an electrical circuit between the current collectors (112) and the at least two charging rail busbar (330).

### BRIEF DESCRIPTION OF THE DRAWINGS

The presently disclosed subject matter may be more clearly understood upon reading of the following detailed description embodiments of non-limiting exemplary embodiments thereof, with reference to the drawings.

The following detailed description of embodiments of the presently disclosed subject matter refers to accompanying drawings. Dimensions of components and features shown in figures are chosen for convenience or clarity of presentations and are not necessarily shown to scale. Wherever possible, the same reference numbers will be used throughout the drawings and the following description to refer to the same and like parts.

FIGS. 1A-1C are illustrations representing (1A) a top view of a covered battery charging post, (1B) a side view of an exposed battery charging post, and (1C) a top view of an exposed battery charging post, according to some embodiments.

FIGS. 2A-2B are illustrations representing a side view of (2A) a battery tender and (2B) a battery tender at a battery charging post, respectively, according to some embodiments.

FIG. 3 is a scheme representing charging system of the invention according to some embodiments.

FIG. 4 is a scheme presenting DC current flow and communication between at least one battery charging post and an energy management system (EMS).

FIG. 5 is a scheme presenting DC current and flow communication between at least one battery charging post and a battery tender, according to some embodiments of the invention.

FIGS. 6A-6B are illustrations presenting the charging and swapping station of the invention, according to some embodiments of the invention.

### DETAILED DESCRIPTION OF THE PREFERRED EMBODIMENTS

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The following are exemplary embodiments of the present invention. The terminology used to describe various assemblies and components is used in a generic sense; variations in terminology may exist to denote like or similar components in different embodiments of the invention.

As used herein, the term “train”, and “locomotive” interchangeably refer in a non-limiting manner to one or several rail-connected vehicles and/or road, trail, cable, support or path-constrained vehicle, including e.g., manned or unmanned vehicle, automatic or autonomous vehicle, which may include railroad vehicles of the present invention, that are capable of being moved together along a guideway, such as rail tracks, a railway, a rail line, a commuter line, to transport freight and/or passengers and a freight line (any one of which may be a train that rolls, or a train that is magnetically levitated). While a train generally includes one or more locomotives to provide power for locomotion along rail tracks, trains comprising embodiments of the present invention may power along a microgrid of rail tracks without a locomotive. The terms may be used here to mean a vehicle that moves along a rail, a vehicle that moves along a guideway as in a maglev train system, or a wheeled vehicle that must follow a catenary in order to receive electric power from the catenary for powering the vehicle.

The term “train” also means single vehicle, or any plurality of such vehicles connected in tandem. Those terms also refer to a trolley car or any other kind of rail vehicle that is unconnected to other vehicles in tandem but moves along a rail or guideway, or a car in a train of cars pulled by an engine, or a vehicle of a maglev train, or a wheeled bus that must be steered so as to follow a catenary system from which it receives electric power. Such a vehicle can be connected in a train or not be connected to any other such vehicles, and can move under the force of a separate train engine vehicle pulling or pushing the vehicle, or it can move using electric power provided by an external source via a catenary system or a via a third rail (possibly in combination with a fourth rail) or it can move under forces provided by a guideway (which forces are usually magnetic, and typically springing from electromagnetic systems). The train is a part of a railroad system (also used herein as a “rail system”). In some embodiments, the rail system comprises at least one of the following elements: spur tracks, tracks, platforms, stations, signaling systems, switches and crossings, yards, bridges and tunnels, catenary system, or control centers, including any combination thereof. In some embodiments, the catenary system provides electrical power to the train. In some embodiments, the spur tracks refer to a rail road track that is branched off form a main.

As used herein, the terms “battery”, “battery tender” are used interchangeably, and refer for example to all elements that may be selected from the set which comprises, by way of non-limiting example, electrochemical accumulators, fuel cells, supercapacitors, and any possible combination thereof.

As used herein, the terms “solar power” and “solar electrical power” are used interchangeably and refer to the converted sun-light into solar electrical power. Solar power is renewable, sustainable and considered environmentally friendly. Typically, solar power produces direct current (DC).

As used herein, the term “power source” refers to the device or system that provides the energy needed to generate electricity. As used herein, the term “power supply” refers to a device or system configured to provide electrical energy to an electric load. The power supply receives electrical power from a power source and converts it to an electrical current from one form or voltage levels to another to provide stable and controlled output for powering different electronic devices or systems.

As used herein, the terms “convertor” and “power supply convertor” refer to a device that converts electrical energy from one form to another.

A “transformer” refers to a device that transforms electrical energy between two or more circuits through electromagnetic induction. Transformers are commonly used to change the voltage level of alternating current (AC) electrical power. A “rectifier” refers to a device that converts AC into direct current DC.

As used herein, the terms “weather-proof battery charging post”, “battery charging post” and “charging post” are used interchangeably and refer to a post where the charging of a battery occurs.

As used herein, the term “energy management system (EMS)” refers to a system or set of tools and processes designed to monitor, control and optimize use of energy. EMS improves energy efficiency, reduces energy consumption and lower overall energy costs.

As used herein, the term “off-grid” refers to a system or location that operates independently of the main electricity grid. In off-grid systems, generation, storage and consumption of the electricity is on site, an off-grid system does not rely on external power sources or grids.

As used herein, the term “current collector” refers to a device or component in an electrical system designed to collect electric current from one location and facilitate its transfer to another. In some embodiments, the current collector enables the flow of an electrical current between different parts of an electrical system.

As used herein, the term “sensor” refers to a device or instrument that detects or measures physical properties, changes in the environment, or conditions and converts this information into signals or data that can be interpreted, displayed, or used for further processing. In some embodiments, the sensor is configured to detect the presence of a battery tender above the battery charging post.

As used herein, the term “busbar” is a conductor in a shape of a bar or strip. The busbar an electric conductor configured to distribute electric power within an electric system. The busbar is characterized by low resistance, and excellent electrical conductivity. A “DC busbar” refers to an electric conductor configured to distribute direct current. A “positive DC” busbar refers to a conductor or a set of conductors within an electrical system that carries direct current from a source to a load. A “negative DC” busbar refers to a conductor or a set of conductors within an electrical system that carries direct current from the load back to the source. The source provides the electrical energy that flows through the conductors. The load is a device or component consuming the electrical power. Negative DC conveys power from the battery tender to the EMS, while positive DC transfers power from the EMS to a battery tender. The bidirectional flow of DC between the EMS and the battery tender enables the closure of an electrical circuit, facilitating the charging process for the battery tender charging of the battery tender.

As used herein, the term “rail busbar” is an electrical distribution system used to distribute power. Rail busbar comprises conductors for carrying the electrical current, isolation layer for safety, mounting rails configured to enable easy access for installation and/or connection. The rail busbar is a flexible system that can be easily customized to meet specific requirement. The terms “charging rail busbar”, “charging rail” and “rail busbar” are used interchangeably.

As used herein, the term “wireless communication” refers to transmission of information between devices that are not physically connected. Wireless communication typically relies on electromagnetic signal. Non-limiting example of electromagnetic signal include but are not limited to radio waves, microwave, or infra radiation, including any combination thereof.

As used herein, the term “energy efficiency” refers to how effectively an energy source is used, in this case, how efficiently is the power source charging a battery tender. The energy efficiency affects various features in a system such as energy waste, costs, and environmental pollution.

As used herein the, term “contactor” refers to a component in an electrical system that controls flow of electrical current through a circuit. A contactor is an electrically-controlled switch used for controlling electrical power circuit. Contactors play a crucial role in the automation and control of electrical systems, allowing for the remote or automatic operation of electrical circuits.

As used herein, the term “ballast” refers to a compact and stable layer typically of crushed stones or rocks that form the foundation of a railroad. The ballast provides stability and support to a track. The ballast distributes the load of weight of the train preventing the track from sinking into the ground. Additionally, the ballast provides stability, resists deformation and settlement under the loads imposed by a passing train, and it ensures the track remains level and aligned. The gaps and spaces between the stones prevent water accumulation.

As used herein, the term “battery management system (BMS)” is an essential component in energy storage systems. BMS is essentially in rechargeable batteries. The BMS controls and monitors parameters such as voltage, current, and temperature of the battery to ensure safe and efficient operation. BMS estimates the state of charge and indicates the current energy level in the battery and the overall health and capacity of a battery over time. BMS maintains a uniform charge level of battery cells, which improves the efficiency and lifespan of the battery. The BMS can disconnect a battery cell that deviates from its normal operation. Typically, BMS comprises communication interface that enables real-time data and status updates. Communication can include with an external system such as a battery EMS, or an external EMS computer.

As used herein, the term “higher-level system” refers to a central system that forecast the demand for a battery tender in a specific charging and swapping station.

The invention discloses, in one set of its embodiments a charging and swapping station for battery tenders.

According to an aspect of the invention, there is disclosed a charging station (CS) (100) along a rail road track, characterized by at least one weather-proof battery charging post (110) located below the rail.

In some embodiments, at least one battery charging post 110 comprises at least 2 current collector (112), a sensor (116), and a spring loaded mechanism or a pneumatic system (118). In some embodiments, the at least 2 current collectors (112) refer to a device or component configured to collect electrical current from the power supply and transport DC 170 to a positive charging rail busbar (332), and receive DC 170 from a negative charging rail busbar (331). In some embodiments, the number of current collectors in a battery charging post (110) is even. In some embodiments, number of current collectors 112 effects the charging rate. In some embodiments, the higher the number of current collectors 112 the greater feasible charging rate. In some embodiments, at least 6 current collector 112 are connected to at least 3 DC 170.

In some embodiments, the sensor is configured to detect presence of a battery tender above at least one battery charging post 110. In some embodiments, non-limiting examples of sensors include but are not limited to photodetectors, weight sensors, laser sensors, photoelectric sensor or proximity sensors, including any combination thereof. In some embodiments, non-limiting examples of proximity sensors include but are not limited to infrared proximity sensors, ultrasonic proximity sensors, magnetic proximity sensors, inductive proximity sensors, or capacitive proximity sensors, including any range in between.

In some embodiments, the spring-loaded mechanism or the pneumatic system (118) is configured to elevate and lower the current collectors upon detection of a battery tender above at least one battery charging post 110. In some embodiments, the spring load or the pneumatic system (118) upon elevation of current collector 112 are configured to enable a good connection between current collector 112 and a changing rail busbar 331 and 332.

In some embodiments, the at least one battery charging post 110 further comprises at least one charging rail cleaner (114). In some embodiments, at least one charging rail cleaner 114 is configured to clean rail and charging rail busbars (331 and 332) located under a battery tender (300). In some embodiments, cleaned rail and busbar are essential for efficient charging, prevention of corrosion and/or oxidation, heat dissipation, safety, or reliable/repeatable performance, including any combination thereof.

In some embodiments, the at least one battery charging post (110) is located below a railroad track. In some embodiments, the at least one battery charging post (110) is installed beneath the rail track. In some embodiments, the at least one battery charging post (110) is contained within a weatherproof compartment (115). In some embodiments, weatherproof compartment 115, is located in railroad ballast. In some embodiments, the weatherproof compartment is configured to protect the at least one battery charging post (110) from environmental conditions and weather conditions. In some embodiments, weatherproof compartment 115 comprises metal, metal oxides, ceramics, polymers, or compositions, including any combination thereof. In some embodiments, weatherproof compartment 115 comprises or is cement.

In some embodiments, weatherproof compartment 115 comprises a slidable cover (120), configured to cover and protect the at least one battery charging post (110). In some embodiments, slidable cover 120 is made of a group consisting of ceramics, metals, metal oxide, or polymers, including any combination thereof. In some embodiments, upon arrival and detection of a battery tender to the at least one battery charging post, the cover slides and exposes the at least one battery charging post. In some embodiments, slidable cover 120 slides on rails 125. In some embodiments, weatherproof compartment 115 further comprises at least one drainage (135). In some embodiments, the at least one drainage (135) is configured to remove water from weatherproof compartment 115. In some embodiments, the at least one drainage (135) prevents water logging, and water flooding within weatherproof compartment 115.

In some embodiments, CS 100 comprises a power supply (410, 420). In some embodiments, the power supply is configured to supply power to at least one battery charging post 110. In some embodiments, the power supply is selected from the group consisting of on-grid (410), off-grid (420), or any combination thereof. In some embodiments, the power supply is a dual power source. In some embodiments, dual power source comprises on-grid 410 and off-grid 420 power source. In some embodiments, on-grid power source 410 refers to electrical power supplied through an electrical grid. In some embodiments, off-grid power source 420 refers to a system or location that operates independently of the main electricity grid. Non-limiting examples of off-grid power sources include but are not limited to solar power, wind power, hydroelectric power, micro hydropower, biomass power, biogas power, fuel cells, or thermal energy, including any combination thereof. In some embodiments, the off-grid power source comprises or is solar power. In some embodiments, off-grid power source 420 is a renewable power source.

In some embodiments, the power supplied (170) to the at least one battery charging post (110) is defined as low voltage International Electrotechnical Commission (IEC). In some embodiments, the power supplied (170) to the at least one battery charging post (110) is characterized by a current lower than 1500 Volt DC. In some embodiments, the power supplied (170) to the at least one battery charging post (110) comprises off-grid power source, on-grid power source, or any combination thereof.

In some embodiments, CS 100 comprises an energy management system (EMS) (160). In some embodiments, EMS 160 is configured to continuously control a current supplied (148) by the on-grid power source (410) to each of the at least one battery charging post (110). In some embodiments, EMS 160 regulates both the utilization and extent of the power source. In some embodiments, EMS 160 decides whether to use off-grid or on-grid power source and by what extent in each charging post 110. In some embodiments, EMS 160 optimizes energy cost of charging a battery. In some embodiments, current 148 supplied by on-grid 410 is controlled by a contactor (147). In some embodiments, contactor 147 is configured to control the flow of electrical current from on-grid 410, by opening or closing an electrical circuit. In some embodiments, opening refers to preventing a flow of electrical current. In some embodiments, closing refers to allowing flow of electrical current. In some embodiments, the EMS (160) controls contractor 147.

In some embodiments, EMS 160 further comprises sensor which measures various parameters such as energy consumption, power quality, temperature, humidity, or occupancy, including any combination thereof.

In some embodiments, the EMS (160) monitors and measures in real-time the status of the on-grid and off-grid power sources. In some embodiments, the EMS (160) controls the amount of power supplied by the on-grid and the off-grid power source. In some embodiments, the EMS (160) controls the amount of power supplied by the on-grid power source and solar power. In some embodiments, use of low amounts of on-grid power source decreases the energy cost. In some embodiments, optimization of the energy cost is performed by controlling the amount of on-grid power source used compared to the off-grid power source used. In some embodiments, optimization of the energy cost is performed by controlling the amount of grid power source used compared to the solar power source used. In some embodiments, grid power costs are affected by peak and off-peak hours, time of use during the day, market conditions and regulations, seasonal variations, or infrastructure and transmission costs, including any combination thereof. In some embodiments, controlling the extent of on-grid power source used highly affects the energy cost of battery charging.

In some embodiments, CS is an optimized energy CS characterized by a minimum energy waste and maximum energy efficiency. In some embodiments, optimization is conducted by an algorithm configured to solve a mixed integer optimization model. Non-limiting examples of algorithm include but are not limited to Branch-and-Bound Algorithm for Energy Optimization, Particle Swarm Optimization for Smart Grids, Mixed-Integer Linear Programming (MILP) for Industrial Energy Management, Simulated Annealing for Energy-Efficient Routing, Tabu Search for Renewable Energy Integration, or Dynamic Programming for Time-of-Use Pricing Optimization, including any combination thereof.

In some embodiments, EMS 160 comprises a DC busbar (138), a point-to-point communication line (136) with each of at least one battery charging post 110, a wireless communication, and a computer (130) configured to enable data processing and optimization of the charging. In some embodiments, computer 130 communicates (136) with at least on battery charging post (110). In some embodiments, communication 136 comprises or is a wireless communication, a line communication, or any combination thereof.

In some embodiments, DC busbar 138 is configured to distribute DC within an electrical system. In some embodiments, DC busbar 138 is connected to the power supply (148 and 152) and the at least one battery charging post (110). In some embodiments, DC busbar 138 comprises or is a metal. In some embodiments, non-limiting examples include but are not limited to aluminum or copper. In some embodiments, non-limiting examples of busbar 138 shape include but are not limited to flat bars, tubular bars, enclosed bus ducts, or channel bars, including any combination thereof. In some embodiments, the bus bar is characterized by a rectangular, a circular, an elliptical, a cylindrical, a square, or an irregular shape. A person skilled in the art would appreciate that the busbar shape can differ from busbar to busbar.

In some embodiments, DC busbar 138 comprises two busbars, a first busbar and a second busbar. The first DC busbar (180) is configured to transfer current to a battery tender charging rail busbar 332 upon charging (also used herein as “positive rail busbar”). The second DC busbar (190) is configured to receive return current from a battery tender charging rail busbar 331 (also used herein as “negative rail busbar”) upon charging. By transferring current from busbar 180 to the positive charging rail busbar 332, and from charging rail busbar 332 to busbar 190 an electrical circuit is closed and charging of battery tender occurs.

In some embodiments, point-to-point communication refers to a data transfer between two communication endpoints, a sender and a receiver. In some embodiments, point-to-point communication is characterized by low latency.

In some embodiments, the EMS (160) is connectable to at least 2 DC 170 connectable to the at least one battery charging post (110). In some embodiments, the EMS controls at least 2 DC circuits per one charging post (110).

In some embodiments, EMS further controls an at least one contractor (168). In some embodiments, the at least one contractor (168) configured to control flow of DC 170 to the at least one battery charging post (110). In some embodiments, the at least one contractor (168) is configured to open or close an electrical circuit with the at least one battery charging post (110). In some embodiments, a closed electrical circuit flow of DC 170 to at least one battery charging post 110. In some embodiments, a closed electrical circuit enables charging of a battery tender. In some embodiments, EMS communicates with contactor 168 by line communication 134.

In some embodiments, EMS 160 control the flow of current using contactor 168 configured to open or close an electrical circuit. In some embodiments, on-off switch 168 prevents or allows flow of DC 170 to at least one battery charging post 110.

In some embodiments, the CS comprises a power supply converter for converting alternating current (144) to direct current (148). In some embodiments, the power supply converter comprises (i) a transformer (142) and (ii) a rectifier (146) or a bi-directional inverter. In some embodiments, transformer 142 lowers the on-grid power to 1500 Volt AC. In some embodiments, rectifier 146 or bi-directional inverter convert 1500 Volt AC to 1500 Volt DC 148.

In some embodiments, EMS 160 is further configured to at least process and analyze data obtained from the power supply, battery EMS, bus bar, including any combination thereof; apply analytical modules to assess energy efficiency, forecast consumption or identify opportunities for optimization, including any combination thereof; utilize optimization algorithms to determine an energy-efficient operation strategy including cost, demand response, and environmental response, report, alert and notify on performance indicators, abnormal conditions, potential energy waste, and opportunities for improvement and, monitor the impact of implemented strategies and adjusting parameters.

According to another aspect of the invention, there is provided a CS (100) of a battery tender (300) comprising a charging system having (i) at least one battery charging post (110) for charging battery tender 300, (ii) a power supply (410 and 420) configured to supply power to at least one battery charging post, and (iii) an energy management system (EMS). In some embodiments, the charging system further comprises a power supply converter for converting alternating current (AC) to direct current (DC). In some embodiments, charging is by a DC current (170). In some embodiments, the DC current is characterized by a current lower than 1500 vdc.

In some embodiments, the battery tender (300) comprises at least two charging rail busbars, a battery management system (BMS) (350); and a battery tender EMS (310). In some embodiments, battery tender 300 further comprises a controller (315). In some embodiments, controller 315 integrates between battery tender EMS 310 and BMS 350.

In some embodiments, one negative charging rail busbar (331) and one positive charging rail busbar (332) are connected to at least one DC 170. In some embodiments, the number of DC 170 depend on the number of current collectors 112, since a pair of current collectors 112 are connected to one DC 170. In some embodiments, each of at least one DC 170 comprises a negative DC 172 and a positive DC 174. The negative DC 172 carries DC from a negative charging rail (331) to busbar 190, by contacting current collectors 112 with the battery charging rails. The positive DC 174 carries DC from busbar 180 to positive charging rail (332). In some embodiments, contactor 168 is located on the DC 174, by contacting current collectors 112 with the battery charging rails.

In some embodiments, the battery tender (300) comprises three charging rail busbars, two 331 charging rail busbars and one 332 charging rail busbar. In some embodiments, charging rail busbar 332 is located between two charging rail busbars 331. In some embodiments, at each charging only one of the 331 rail busbar participates and the charging process of a battery tender. In some embodiments, the rail busbar used, depends on how a locomotive is located in the at least one battery charging post (110).

In some embodiments, battery EMS 310 and BMS 305 are communicable. In some embodiments, battery EMS 310 and BMS 305 are connected by wire connection, wireless connection, or any combination thereof. In some embodiments, battery EMS 310 is in communication with computer 130. In some embodiments, the communicates between battery EMS 310 and computer 130 comprises or is wireless communication.

In some embodiments, charging occurs upon entrance of a battery tender to a battery charging post (110), and detection of the battery tender by a sensor (116). In some embodiments charging comprises (i) uncovering at least one battery charging post 110 (ii) raising current collectors 112 from beneath the railroad, (iii) contacting current collectors 112 with two battery rail busbars (331, 332), (iv) verifying all is in place, and (v) closing an electrical circuit, and charging begins. In some embodiments, the verifying step comprises communication between the EMS and the battery tender. In some embodiments, current is supplied by closing an electrical circuit. In some embodiments, an electrical circuit is closed by contacting an at least one pair of current collectors 112 with the two rail busbars 331 and 332, and contactor 168 enable a flow of DC between them. In some embodiments, power is supplied by closing an electrical circuit.

In some embodiments, the CS station further comprises a battery swapping installation for replacing at least one onboard locomotive battery with an externally stored charged battery. In some embodiments, the swapping system comprises an at least one decoupling post (520) and an at least one coupling post (550). In some embodiments, in the at least one decoupling post 520 at least one discharged battery tender is decoupled from the onboard locomotive. In some embodiments, the decoupling step results in the onboard locomotive lacking at least one battery tender (also referred to herein as decoupled locomotive). In some embodiments, the decoupled locomotive is devoid of a battery tender. In some embodiments, in the at least one coupling post at least one charged battery is coupled to a locomotive. In some embodiments, a locomotive lacking of at least one battery tender enters the coupling post 550, and is coupled to at least one charged battery tender. In some embodiments, the decoupling post is an empty rail track. In some embodiments, the coupling post is a rail track comprising a charged battery. In some embodiments, the decoupling and coupling posts 520 and 550 respectively comprise at least one charging post 110.

In some embodiments, the coupling of a battery tender and a locomotive comprises or is a mechanical coupler. In some embodiments, the mechanical coupler is designed to connect between the locomotive and the battery tender. In some embodiments, the coupling step comprises: (i) aligning the locomotive and the battery tender, and (ii) engaging and securing the connection.

In some embodiments, the battery tender and the locomotive are further connected by air connections configured to control braking. In some embodiments, the battery tender and the locomotive are further connected by electrical connections. In some embodiments, the electrical communication is essential for the communication of electrical signals and power through the train.

In some embodiments, the decoupling of a battery tender and a locomotive comprises decoupling the mechanical coupler. In some embodiments, the decoupling step further comprises decoupling the air and electrical connection between the battery tender and the locomotive.

In some embodiments, the term battery tender refers to a substantially discharged battery tender (370), a substantially charged battery tender (350). As used herein, the tern substantially refers to at least 70%, at least 75%, at least 80%, at least 85%, or at least 90%, including any range or value in between.

In some embodiments, the CS station of the present invention is integrated into an existing rail network.

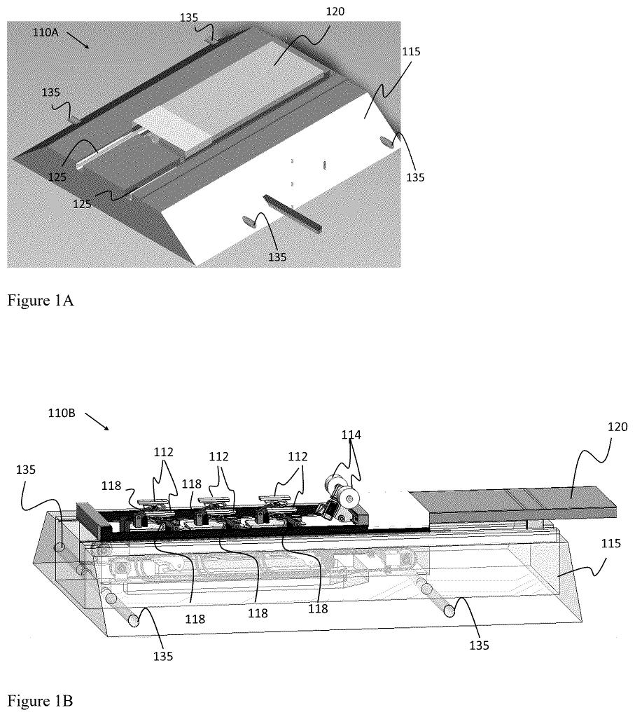

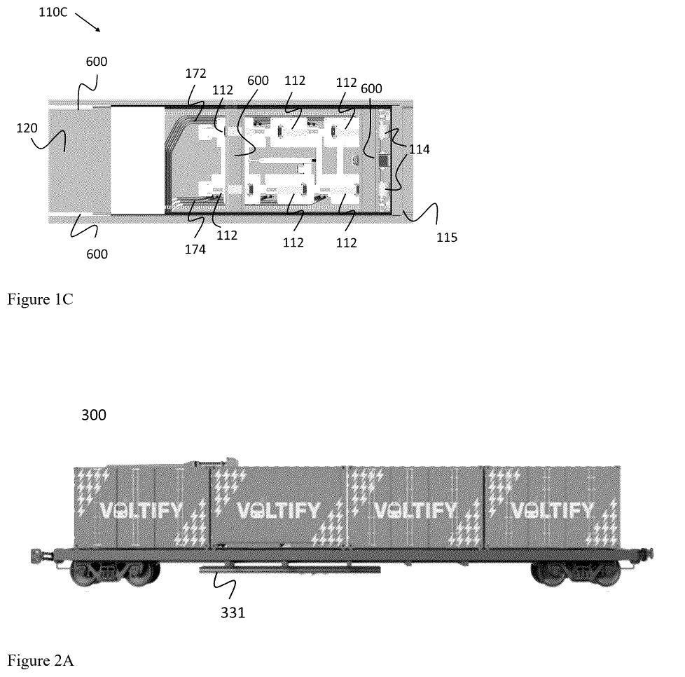

Reference is now made to FIGS. 1A-6C exemplary illustration of the present invention according to some embodiments.

FIG. 1A represents a top view of a covered battery charging post (110A) having weatherproof compartment 115, cover 120, four drainage 135, and two tracks 125. In some embodiments, drainage 135 is configured to remove water or other liquids from weatherproof compartment 115. In some embodiments, cover 120 slides on tracks 125, this facilitates easy exposure and sealing of the battery charging post (110). In some embodiments, cover 125 exposes the battery charging post when a battery tender enters the charging post, and covers the battery charging post when the battery tender exits the battery charging post. In some embodiments, the cover movement is triggered by a sensor, that detects the presence of a battery tender within the charging post. In some embodiments, battery charging post comprises a sensor for detecting presence of a battery tender.

FIG. 1B illustrates a side view of an exposed battery charging post (110B) protected by a weatherproof compartment 115 and a cover 120. The battery charging post comprises four (only three are seen) drainage (135) configured to remove water or other liquids from weatherproof compartment 115, three pairs of current collectors 112, two charging rail cleaners 114, and six spring loaded mechanisms (118). In some embodiments, weather compartment 115 is under-level ground. In some embodiments, under-level ground refers to the railroad tracks. In some embodiments, weather compartment 115 is located in track ballast. In some embodiments, cover 120 is at level ground. In some embodiments, current collectors 112 are raised to engage with a pair of battery tender rail charging busbars to close an electrical circuit and enable the charging of a battery tender. In some embodiments, current collectors 112 are raised with the exposure of the battery charging post and lowered when charging is complete. In some embodiments, spring loaded mechanisms 118 is configured to elevate and lower current collectors 112. Furthermore, elevating and lowering current collectors 112 can be done by a pneumatic system. In some embodiments, battery charging post comprises a sensor for detecting presence of a battery tender.

FIG. 1C represents a top view of an uncovered battery charging post (110C) having a weather compartment 115, three pairs of current collectors 112, and two charging rail cleaners 114. Three current collectors are connected to DC 174, and three current collectors are connected to DC 172. In some embodiments, the weather compartment (115) is located in track ballast, beneath rail track. In some embodiments, DC 172 carries DC from a negative charging rail to a busbar, by contacting current collectors 112 with the battery charging rails. In some embodiments, DC 174 carries DC from a busbar to positive charging rail busbar. In some embodiments, charging rail cleaners 114 are configured to clean rail and busbars under a battery tender. In some embodiments, battery charging post comprises a sensor for detecting presence of a battery tender.

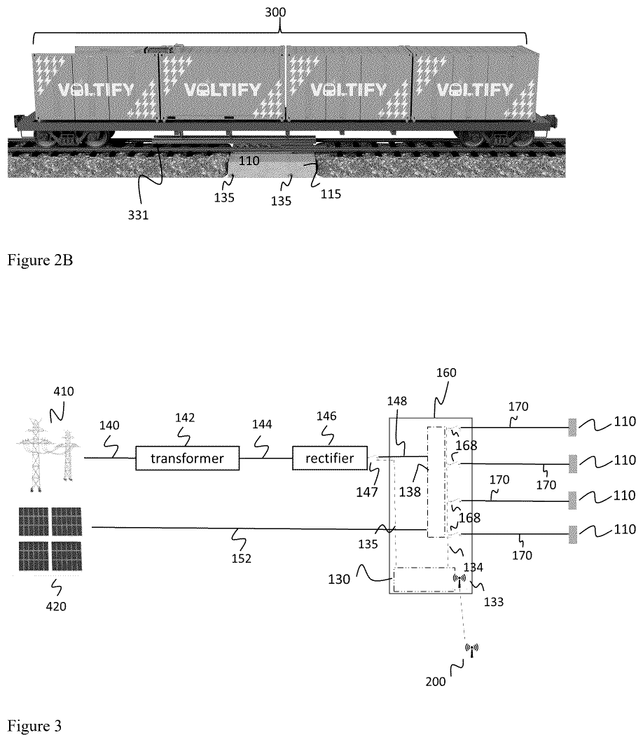

Reference is now made to FIGS. 2A-2B illustrating (2A) the battery tender and (2B) battery tender at a battery charging post, respectively. FIG. 2A shows battery tender 300 and charging rail 330. FIG. 2B demonstrates battery tender 300 in charging post 110. The weather compartment 115 is seen as well as two drainages. Battery tender 300 comprises a pair of charging rail busbars (331 and 332, only one is seen). In some embodiments, by closing an electrical circuit between the pair of charging rail busbars (331 and 332) and current collector 112, current flows and charging begins. In some embodiments, in order to close an electrical circuit first a successful contraction between current collector 112 and the pair of charging rail busbars (331 and 332) is required and second EMS 160 commands contactor 168 to close an electrical circuit.

Reference is now made to FIG. 3 a scheme of the charging system of the present invention according to some embodiments of the invention. An on-grid power source (410) supplies AC (140) to a transformer (142) configured to reduce the AC Voltage (144) which is then transferred to a rectifier that converts the AC voltage to a DC voltage (148). An off-grid power source (420) supplies solar power characterized by a DC (152) output. The power supply 148 and 152 are supplied to a DC busbar (138). EMS 160 controls the amount of on-grid power supplied to DC busbar 138, using a contactor (147) configured to open and close an electrical circuit. EMS 160 further controls a contactor 168 configured to close and open an electrical circuit between at least a pair of current collectors 112 (not seen) with a pair of charging rail busbars (331 and 332, not seen). Both contactors 147 and 168 are controlled by EMS 160. DC busbar 138 is connected to power supply 170 and to four battery charging posts 110. The power supply 170 is controlled by the EMS by opening and closing contactor 168. EMS further comprises point-to-point communication line 136 with each battery charging post 110, a wireless communication 133, a computer 130, communication line 134 configured to communicate with contactor 147, and communication line 135 configured to communicate with contactor 168. In some embodiments, wireless communication 133 enables communication between EMS battery tender 300 and/or higher-level systems (200). In some embodiments, transformer 142 is configured to reduce the AC to 1500 Volt AC (144) which is then transferred to a rectifier that converts the 1500 Volt AC to 1500 Volt DC (148). In some embodiments, the off-grid power source (420) supplies solar power characterized by at most 1500 Volt DC (152). In some embodiments, computer 130 is configured to enable data processing and optimization of the charging process.

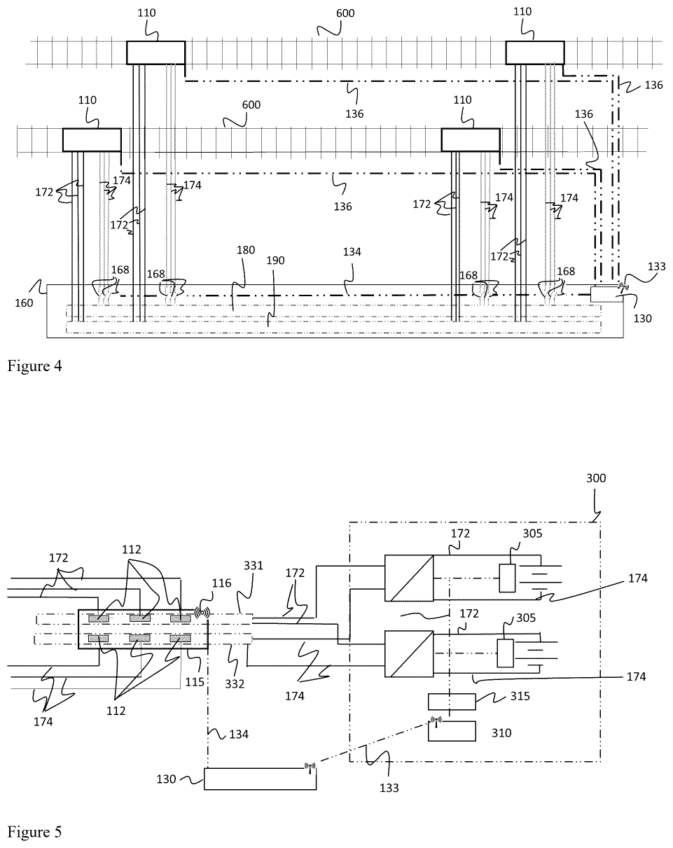

Reference is now made to FIG. 4 an illustration of the connection between the EMS 160 and four battery charging posts 110. Each battery charging post is located beneath a rail road (600) and is connected to DC. Each current collector is connected to one DC. In this example, charging post 110 comprises six current collectors (112, not seen in the figure) each connected to a direct current. Three current collectors are connected to a negative DC 172 and three to a positive DC 174. EMS 160 comprises two DC busbars 190 and 180, and a computer 130. EMS further comprises wireless communication 133. Each battery charging post 110 is communicable with computer 130.

In some embodiments, negative DC 172 carries DC from a negative charging rail (331) to busbar 190, by contacting current collectors with the battery charging rails. In some embodiments, positive DC 174 carries DC from busbar 180 to positive charging rail (332). In some embodiments, contactor 168 is located on the DC 174, by contacting current collectors 112 with the battery charging rails. In some embodiments, communication comprises or is a wireless communication, a line communication, or any combination thereof. In some embodiments, computer 130 is configured to enable data processing and optimization of the charging process. In some embodiments, contactor 168 is configured to open and close an electrical circuit. In some embodiments, a closed circuit enables the flow of DC current and the charging of a battery tender. In some embodiments, contactor 168 is controlled by EMS 160. In some embodiments, wireless communication 133 enables communication between EMS battery tender 300. In some embodiments, the connection between EMS 160 and battery charging post 110 is essential for controlling the charging process.

Reference is now made to FIG. 5 an illustration presenting direct current flow between a battery charging post with a battery tender. FIG. 5 demonstrates how the rail busbars are aligned and located compared to current collectors 112, and the current movement from six current collectors 112 to battery tender 300. DC 172 transfers current from three current collector 112 to a battery charging rail 332, and DC 174 transfers current form battery charging rail 331 to reaming three current collectors. Line communication 134 connects between the battery charging post and EMS computer 130. Computer 130 is further connected by wireless communication to a battery tender EMS 310. The battery EMS 310 is connected to BMS 305 through a controller 315. In some embodiments, communication occurs by line communication, wireless communication, or any combination thereof.

In some embodiments, BMS 305 is configured to monitor, control battery, and optimize operation, performance, safety, or lifespan of a battery, including any combination thereof. In some embodiments, real-time communication between battery EMS 310, BMS 305 and computer 130 is crucial for efficient and optimized charging.

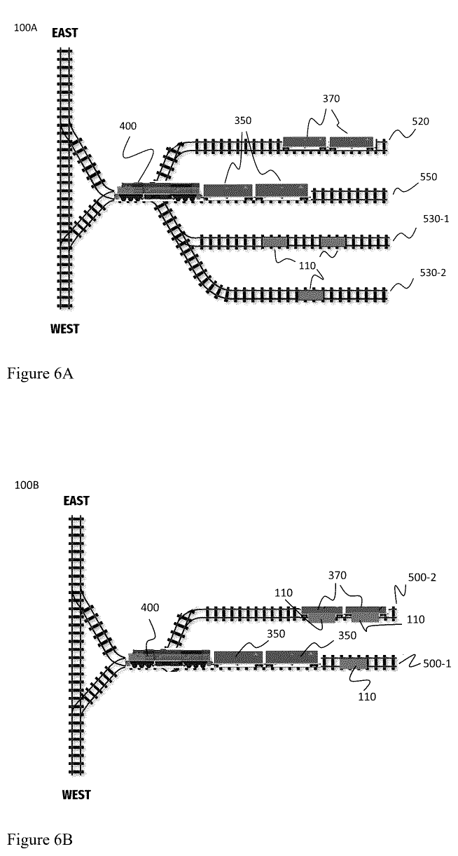

Reference is now made to FIGS. 6A-6B exemplary illustrations of the charging and swapping station (100) of the present invention. FIG. 6A shows a rail network comprising a charging and swapping station (100A). Charging comprises an at least one battery charging post, 110. Tracks 530-1 and 530-2 comprise charging post 110. Track 530-1 comprises two battery charging post and 530-2 has one. Swapping comprises a decoupling post 520, and a coupling post 550. The decoupling post 520, has a discharged battery (370) and coupling post 520 is vacant. A locomotive is seen exiting coupling post 550, where it was coupled to two charged battery 350 tenders. In some embodiments, the discharged battery in post 520 is moved, to empty the post, and enable its utilization. In some embodiments, a charged battery is moved to post 550.

FIG. 6B demonstrates that each track in the charging and swapping rail network (100B) can act as a charging and a swapping station. A locomotive is seen exiting a track (500-1), where it was coupled to two charged battery 350 tenders, after the locomotive discharged batteries 370 where decoupled at an empty track (500-2). Each track in the CS rail network comprises an at least one charging post 110. In some embodiments, the charging post are configured to charge the decoupled discharged battery 370.

According to another aspect, there is disclosed a method for assembling a CS within an existing rail network comprising at least one weather-proof battery charging post (110) located below a railroad track. In some embodiments, at least one weather-proof battery charging post 110 is contained within a weatherproof compartment (115).

In some embodiments, at least one battery charging post 110 is installed below a railroad track. In some embodiments, at least one battery charging post 110 is installed within track ballast. In some embodiments, at least one battery charging post 110 is installed under level ground. In some embodiments, an at least one rail track comprises at least one battery charging post 110.

In some embodiments, the method comprises a dual power supply (410 and 420). In some embodiments, a dual power supply comprises an on-grid power source and off-grid power source. In some embodiments, the existing rail network comprises an on-grid power source (410). In some embodiments, on-grid power source 410 is connected to a converter. In some embodiments, the converter comprises (i) a transformer (142) and (ii) a rectifier (146) or a bi-directional inverter. In some embodiments, the converter is for converting AC to DC. In some embodiments, the DC is characterized by a voltage of at most 1500 Volt DC. In some embodiments, power supplied to the at least one battery charging post (170) is characterized by a current of at most 1500 Volt DC.

In some embodiments, the method comprises EMS 160 for continuously controlling current supplied by the dual power source.

In some embodiments, the method comprises a power supply converter (142, and 146) for converting alternating current (144) to direct current (148).

In some embodiments, the method further comprises a battery swapping installation for replacing at least one onboard locomotive battery with an externally stored charged battery. In some embodiments, the swapping installation comprises at least one battery tender (300). In some embodiments, at least one battery tender 300 is charged and ready to be exchanged. In some embodiments, at least one battery tender 300 is uncharged and needs to be charged in at least one charging post 110. In some embodiments, the swapping installation further comprises storing unit to store an at least one battery tender. In some embodiments, charging and swapping occur on the same track. In some embodiments, charging and swapping occur on different tracks. In some embodiments, the method is for assembling the CS station of the present invention.

According to another aspect, there is disclosed a method for assembling a CS (100) within an existing rail network comprising an at least one battery charging post (110), a dual power supply (410, 420) configured to supply power to at least one battery charging post 110, an energy management system (EMS) (160), a power supply converter (142, and 146) for converting alternating current (144) to direct current (DC) (148); and a rail network.

In some embodiments, the method further comprises a battery swapping installation for replacing at least one onboard locomotive battery with an externally stored charged battery. In some embodiments, the swapping installation comprises at least one battery tender (300). In some embodiments, at least one battery tender 300 is charged and ready to be exchanged. In some embodiments, at least one battery tender 300 is uncharged and needs to be charged in at least one charging post 110. In some embodiments, the swapping installation further comprises storing unit to store an at least one battery tender.

In some embodiments, charging and swapping occur on the same track. In some embodiments, charging and swapping occur on different tracks. In some embodiments, the method is for assembling the CS station of the present invention.

According to another aspect, there is disclosed a method for charging a battery tender (300) comprising the battery tender and an at least one weather-proof battery charging post (110) located below a rail road track.

In some embodiments, at least one weather-proof battery charging post 110 is contained within a weatherproof compartment (115). In some embodiments, at least one battery charging post 110 is installed below a railroad track. In some embodiments, at least one battery charging post 110 is installed within track ballast. In some embodiments, at least one battery charging post 110 is installed under level ground.

In some embodiments, the method comprises a dual power supply (410 and 420).

In some embodiments, the method comprises EMS 160 for continuously controlling current supplied by the dual power source.

In some embodiments, the method comprises a power supply converter (142, and 146) for converting alternating current (144) to direct current (148).

According to another aspect, there is disclosed a method for charging a battery tender (300) comprising an at least one battery charging post (110), a dual power supply (410, 420) configured to supply power to the at least one battery charging post (110), an energy management system (EMS) (160); and a power supply converter (142, and 146) for converting alternating current (144) to direct current (DC) (148).

In some embodiments, a locomotive (400) enters the CS station of the invention. In some embodiments, a locomotive enters a track comprising at least one charging post 110. In some embodiments, the locomotive positions the battery tender above the charging post. In some embodiments, sensor 116 detects the presence of a battery tender and initiates the charging process. In some embodiments charging comprises, (i) uncovering at least one charging post 110, (ii) raising at least one pair of current collectors 112 from beneath the railroad, (iii) contacting current collectors 112 with a pair of battery charging rail busbars (331 and 332), (iv) verifying all is in place, and (v) closing an electrical circuit, and charging begins. In some embodiments, the verifying step comprises communication between the EMS and the battery tender. In some embodiments, closing a circle occurs in two steps, the first, contacting at least one pair of current collectors 112 with a pair of battery charging rail busbars (331 and 332), and (ii) commanding contractor 168 to close an electrical circuit formed between the battery tender and the charging post.

In some embodiments, the method further comprises a battery swapping installation for replacing at least one onboard locomotive battery with an externally stored charged battery. According to another aspect, there is disclosed a method for charging a locomotive comprising a locomotive, and the CS station of the invention.

According to another aspect, there is disclosed a battery charging comprising weather-proof battery charging unit located below a rail road track. In some embodiments, the weather-proof battery charging unit comprises an at least one battery charging post (110) contained in a weather-proof compartment (115). In some embodiments, at least one battery charging post 110 is installed within track ballast. In some embodiments, at least one battery charging post 110 is installed under level ground.

In some embodiments, the method comprises a dual power supply (410 and 420).

In some embodiments, the method comprises EMS 160 for continuously controlling current supplied by the dual power source.

In some embodiments, the method comprises a power supply converter (142, and 146) for converting alternating current (144) to direct current (148).

According to another aspect, there is disclosed a system for charging a battery comprising a charging unit, an energy management system (EMS), a power unit, and a converting unit. In some embodiments, the charging unit comprises at least one battery charging post (110). In some embodiments, the power unit comprises a dual power source. In some embodiments, the dual power source comprises off-grid (410) and on-grid (420) power sources. In some embodiments, the converting unit comprises a transformer (142) configured to lower on-grid power 410 to 1500 Volt AC; and a rectifier (146) for converting the 1500 Volt AC to DC 148

In some embodiments, the charging unit is installed below a railroad track.

In some embodiments, the system further comprises a swapping unit. In some embodiments, the swapping unit is for replacing at least one onboard locomotive battery with an externally stored charged battery.

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims which follow.

1.-48. (canceled)

49. A battery charging station (CS) (100) along a railroad track, comprising an at least one weather-proof battery charging post (110) located below said railroad track; and
an energy management system (EMS) (160);
wherein said EMS is configured to at least
process and analyze data obtained from said power supply, battery EMS, bus bar, including any combination thereof;
apply analytical modules to assess energy efficiency, forecast consumption and identify opportunities for optimization, including any combination thereof;
utilize optimization algorithms to determine an energy-efficient operation strategy including cost, demand response, and environmental response;
report, alert and notify on performance indicators, abnormal conditions, potential energy waste, and opportunities for improvement and;
monitor the impact of implemented strategies and adjusting parameters.

50. The CS of claim 49, wherein said at least one weather-proof battery charging post (110) is contained within a weatherproof compartment (115), and said weatherproof compartment (115) comprises a slidable cover (120).

51. The CS station of claim 49, wherein said at least one battery charging post (110) comprises
at least one pair of current collectors (112); and
a proximity sensor (116) for sensing presence of a battery tender above said at least one battery charging post;
a spring-loaded mechanism or a pneumatic system (118) for elevating and lowering said current collectors upon detection of said presence of a battery tender (300).

52. The CS station of claim 49, wherein said at least one battery charging post further comprises an at least one charging rail cleaner (114) configured to clean rail and busbars under a battery tender.

53. The CS of claim 49, wherein said EMS (160) is further configured to continuously control current supplied by said dual power source.

54. The CS of claim 49, wherein said EMS (160) comprises
a DC busbar (138) connected to said power supply (170) and said at least one battery charging post (110);
a point-to-point communication line (136) with each said at least battery charging post (110);
a wireless communication (133) for enabling communication between said EMS (133) and said battery tender (300) and/or higher-level systems (200); and
computer (130) configured to enable data processing and optimization of said charging.

55. The CS of claim 49, wherein said CS comprises a power supply converter (142, and 146) for converting alternating current (144) to direct current (DC) (148); said power supply converter comprises a transformer (142) configured to lower the on-grid power source (410) to 1500 Volt ac; and a rectifier (146) or a bi-directional inverter for converting the 1500 Volt AC to DC 148.

56. The CS of claim 49, wherein said CS comprises a battery swapping installation for replacing at least one onboard locomotive battery with an externally stored charged battery.

57. The CS of claim 49, wherein a battery tender comprises
at least two rail busbars (331 and 332);
battery management system (BMS); and
battery tender EMS.

58. The CS of claim 49, wherein said CS is integrated into an existing rail network.

59. A method for assembling a charging station (100) within an existing rail network comprising an at least one weather-proof battery charging post (110) located below a railroad track; and
an energy management system (EMS) (160);
wherein said EMS is configured to at least process and analyze data obtained from said power supply, battery EMS, bus bar, including any combination thereof;
apply analytical modules to assess energy efficiency, forecast consumption and identify opportunities for optimization, including any combination thereof;
utilize optimization algorithms to determine an energy-efficient operation strategy including cost, demand response, and environmental response;
report, alert and notify on performance indicators, abnormal conditions, potential energy waste, and opportunities for improvement and;
monitor the impact of implemented strategies and adjusting parameters.

60. The method of claim 59, wherein said at least one weather-proof battery charging post (110) is contained within a weatherproof compartment (115), and said weatherproof compartment (115) comprises a slidable cover (120).

61. The method of claim 59, wherein said at least one battery charging post (110) comprises
at least one pair of current collectors (112); and
a proximity sensor (116) for sensing presence of a battery tender above said at least one battery charging post;
a spring-loaded mechanism or a pneumatic system (118) for elevating and lowering said current collectors upon detection of said presence of a battery tender (300).

62. The method of claim 59, wherein said at least one battery charging post further comprises an at least one charging rail cleaner (114) configured to clean rail and busbars under a battery tender.

63. The method of claim 59, wherein said EMS (160) is further configured to continuously control current supplied by said dual power source.

64. The method of claim 59, wherein said EMS (160) comprises a DC busbar (138) connected to said power supply (170) and said at least one battery charging post (110);
a point-to-point communication line (136) with each said at least battery charging post (110);
a wireless communication (133) for enabling communication between said EMS (133) and said battery tender (300) and/or higher-level systems (200); and
computer (130) configured to enable data processing and optimization of said charging.

65. The method of claim 59, wherein said method comprises a power supply converter (142, and 146) for converting alternating current (144) to direct current (DC) (148); said power supply converter comprises a transformer (142) configured to lower the on-grid power source (410) to 1500 Volt ac; and a rectifier (146) or a bi-directional inverter for converting the 1500 Volt AC to DC 148.

66. The method of claim 59, wherein said method comprises a battery swapping installation for replacing at least one onboard locomotive battery with an externally stored charged battery.

67. The method of claim 59, wherein a battery tender comprises
at least two charging rail busbars (331 and 332);
battery management system (BMS); and
battery tender EMS.

68. A battery charging system comprising an at least one charging unit located below a railroad track; and
an energy management system (EMS) (160)
wherein said EMS (160) is configured too at least
process and analyze data obtained from said power supply, battery EMS, bus bar, including any combination thereof;
apply analytical modules to assess energy efficiency, forecast consumption and identify opportunities for optimization, including any combination thereof;
utilize optimization algorithms to determine an energy-efficient operation strategy including cost, demand response, and environmental response;
report, alert and notify on performance indicators, abnormal conditions, potential energy waste, and opportunities for improvement and;
monitor the impact of implemented strategies and adjusting parameters.
